(19) United States
(12) Patent Application Publication
(10) Pub. No.: US 2016/0091188 A1
(43) Pub. Date: Mar. 31, 2016

(54) HELMET AND A LIGHTING SYSTEM FOR A HELMET

(71) Applicants: William Alexander Erwin, Carrickfergus (GB); John Milligan, Coleraine (GB)

(72) Inventor: John Milligan, Coleraine (GB)

(21) Appl. No.: 14/864,350

(22) Filed: Sep. 24, 2015

(30) Foreign Application Priority Data
Sep. 25, 2014 (GB) 1416911.4

(51) Int. Cl. F21V 23/04; A42B 3/04; B60Q 1/34; B60Q 1/44; F21V 23/00; H05B 37/02

(52) U.S. Cl. CPC F21V 23/045; F21V 23/008; F21V 23/0492; H05B 37/0272; H05B 37/0236; B60Q 1/34; B60Q 1/44; A42B 3/044; A42B 3/0453; F21W 2101/02

(57) ABSTRACT

The present invention relates to a lighting system for a helmet of the type worn by a user of a vehicle, such as a motorbike, bicycle, moped or scooter. The system comprises an arrangement of a helmet and a vehicle mounted controller unit and transceiver means, the helmet mounting lighting functions comprising including left and right turning indicator lights, a brake light, and down light means and having a helmet mounted controller unit in communication with the lighting functions. The vehicle mounted controller unit is operable to generate lighting function triggering signals, and a transceiver means mounted to the vehicle is provided for transmission of the lighting function triggering signals to helmet mounted transceiver means, such that the helmet mounted controller unit is operable to activate lighting functions of the helmet in response to the lighting function triggering signals received by the helmet mounted transceiver means. The present invention further relates to a helmet comprising voice activated lighting functions.

The present invention relates to a helmet and a lighting system for a helmet.

Road traffic accidents are often the result of inadequate reaction times by road users to movements made by vehicles such as, but without limitation, bicycles, motorbikes, scooters, mopeds and the like. Accidents also occur due to a failure by road users to adequately see such vehicles, and this is made worse during periods of poor visibility, such as at night or in fog.

It is an object of the present invention to provide headwear with enhanced safety features that go at least some way toward overcoming the above problems and/or which will provide the public and/or industry with a useful alternative.

Further aspects of the present invention will become apparent from the ensuing description which is given by way of example only.

According to a further aspect of the invention, there is provided a lighting system for a helmet of the type worn by a user of a vehicle, such as a motorbike, bicycle, moped or scooter, the system comprising an arrangement of a helmet and a vehicle mounted controller unit and transceiver means, the helmet comprising:
a main body mounting lighting functions comprising one or more of: left and right turning indicator lights, a brake light, and down light means operable to illuminate a region below the main body;
a helmet mounted controller unit in communication with the lighting functions, and
a helmet mounted transceiver means,
whereby, the vehicle mounted controller unit is operable to generate lighting function triggering signals, and transceiver means mounted to the vehicle is provided for transmission of the lighting function triggering signals to the helmet mounted transceiver means, and in which the helmet mounted controller unit is operable to activate lighting functions of the helmet in response to the lighting function triggering signals received by the helmet mounted transceiver means.

Preferably, the vehicle mounted controller unit and vehicle mounted transceiver means are enclosed in a housing unit.

Preferably, the housing unit comprises status indicators for indicating a status of the left and the right turning indicator lights, the brake light and/or the down light means.

Preferably, the housing unit comprises releasable connection means, such as straps or other connection means, for connection to the vehicle.

Preferably, the housing unit is mounted at a position on a cross-bar of the vehicle.

Alternatively, the housing unit is mounted at a position on a handle bar of the vehicle.

In another embodiment of the invention, actuator means of the vehicle mounted controller unit is provided to generate lighting function triggering signals to activate the left and right turning indicator lights.

Preferably, the actuator means is provided as a lever of the housing unit operable to be moved left and right, whereby movement of the lever generates lighting function triggering signals such that movement of the lever to the left activates the left turning indicator light and movement of the lever to the right activates the right turning indicator light.

Preferably, the lever is centrally biased.

Alternatively, the actuator means is provided as a button or a lever mountable to a left side handle bar of the vehicle, and the actuator means for activating the right turning indicator light is provided as a lever or button mountable to a right side handle bar of the vehicle, whereby movement of a lever or activation of a button generates lighting function triggering signals to activate the left turning indicator light and the right turning indicator light.

Preferably, the lighting function triggering signals are transmitted between the helmet mounted transceiver means and the vehicle mounted transceiver means as one or more of: radio frequency (RF) signals; digital wireless signals, GPRS signals and/or Bluetooth signals.

Preferably, the vehicle mounted controller unit comprises an integrated, optionally rechargeable, battery.

Preferably, the vehicle mounted controller unit and vehicle mounted transceiver means are integrated as a computer processor means within the housing unit.

Preferably, the helmet mounted controller unit and helmet mounted transceiver means are integrated as a computer processor means within or mounted to the main body of the helmet.

In another embodiment of the invention, the helmet further comprises audio output means operable to output an audio signal when the left or the right turning indicator light is activated.

In another embodiment of the invention, the left and right turning indicator lights are mounted to the main body of the helmet.

Preferably, the left and right turning indicator lights are integrally formed on the main body.

In another embodiment of the invention, the brake light or brake lights are mounted to the helmet at the rear of the main body.

Preferably, the brake light or brake lights are integrally formed on the main body.

Preferably, the brake light has two modes of operation, whereby in the first mode the brake light is activated such that it is continuously on when the vehicle is decelerating, slowing and/or is stopped, and in the second mode the brake light is activated such that the brake light flashes on and off intermittently at timed intervals when the vehicle is accelerating and/or moving at a constant speed.

In another embodiment of the invention, the brake light is operable in response to lighting function triggering signals received from an accelerometer means adapted to sense the motion of the vehicle.

Preferably, the down light means is activated when ambient light drops below a threshold level.

Preferably, such a threshold level is one of: 1000 lux; 800 lux; 600 lux; 400 lux; 200 lux and 100 lux.

Preferably, the down light means is operable to illuminate a region between the helmet and the ground.

Preferably, the down light means is provided sides of the main body of the helmet.

Preferably, the down light means is provided at left and right sides of the main body of the helmet. Preferably, the brake light, left and right turning indicator lights and the down light means comprises LED lighting means.

Preferably, the helmet comprises an integrated, optionally rechargeable, battery.

Preferably, the helmet and/or the vehicle mounted controller unit comprises a USB port.

Preferably, one of the: helmet mounted controller unit or the vehicle mounted controller unit further comprises GPS location tracking means operable to enable a location of the respective controller unit to be determined, and the GPS location determined is displayed on a map display means mountable to the vehicle in communication with the controller unit and/or output as an audible signal via audio output means of the respective controller unit or helmet.

Preferably, the GPS location tracking means enables a user to input a desired destination, and whereby directions to the destination are provided via map display means and/or audible signals via audio means of the controller unit or helmet.

According to a further aspect of the invention, there is provided a helmet of the type worn by a user of a vehicle, such as a motorbike, bicycle, moped or scooter, the helmet comprising:
a main body mounting voice activated lighting functions comprising one or more of: left and right turning indicator lights, a brake light, and down light means operable to illuminate a region below the main body;
voice activation means comprising audio input means for receiving voice commands from the user,
a controller unit in communication with the voice activation means and lighting functions of the helmet,
whereby, the controller unit is operable to receive and convert the voice commands into lighting function triggering signals for activating lighting functions of the helmet.

Preferably, the voice commands are transmitted to the controller unit via transmission means, such as radio frequency (RF); digital wireless, GPRS and/or Bluetooth transmission means.

Preferably, the controller unit is mounted to the main body of the helmet. Preferably, the main body comprises a housing for the controller unit.

Preferably, the housing unit comprises releasable connection means, such as straps or other connection means, for connection of the controller unit to the helmet.

Preferably, the controller unit is provided as a mobile telephone having computer processor means.

Preferably, the controller unit comprises an integrated, optionally rechargeable, battery.

Preferably, the controller unit is integrated as a computer processor means within the helmet.

In another embodiment of the invention, the helmet further comprises audio output means operable to output an audio signal when the left or the right turning indicator light is activated.

In another embodiment of the invention, the left and right turning indicator lights are mounted to the main body of the helmet.

Preferably, the left and right turning indicator lights are integrally formed on the main body.

In another embodiment of the invention, the brake light or brake lights are mounted to the helmet at the rear of the main body.

Preferably, the brake light or brake lights are integrally formed on the main body.

Preferably, the brake light has two modes of operation, whereby in the first mode the brake light is activated such that it is continuously on when the vehicle is decelerating, slowing and/or is stopped, and in the second mode the brake light is activated such that the brake light flashes on and off intermittently at timed intervals when the vehicle is accelerating and/or moving at a constant speed.

In another embodiment of the invention, the brake light is operable in response to lighting function triggering signals received from an accelerometer means of the controller unit operable to sense the motion of the vehicle.

Preferably, the down light means is activated when ambient light drops below a threshold level.

Preferably, such a threshold level is one of: 1000 lux; 800 lux; 600 lux; 400 lux; 200 lux and 100 lux.

Preferably, the down light means is operable to illuminate a region between the helmet and the ground.

Preferably, the down light means is provided sides of the main body of the helmet.

Preferably, the down light means is provided at left and right sides of the main body of the helmet.

Preferably, the brake light, left and right turning indicator lights and the down light means comprises LED lighting means.

Preferably, the helmet comprises an integrated, optionally rechargeable, battery.

Preferably, the helmet and/or the controller unit comprises a USB port.

Preferably, the controller unit further comprises GPS location tracking means operable to enable a location of the controller unit to be determined, and the GPS location determined is displayed on a map display means mountable to the vehicle in communication with the controller unit and/or output as an audible signal via audio output means of the controller unit or helmet.

Preferably, the GPS location tracking means enables a user to input a desired destination and whereby directions to the destination are provided via map display means and/or audible signals via audio means of the controller unit or helmet.

The present invention advantageously provides a down light means which provides an envelope of safe light that covers at least a portion of the rider of the bicycle or motorbike from the head towards the ground, thereby making the rider more visible to other road users. The provision of a wireless operated direction indicator system together with brake light arrangement which is a constantly running light housed to the rear of the helmet further aids visibility of a rider.

The helmet receives command signals from a vehicle mounted controller unit or pod which is secured to the bicycle or motorbike, such as to the main frame or handle bars.

The vehicle mounted controller unit incorporates a direction indicator switch or lever, which may be moved left or right to illuminate a corresponding left or right direction light indicator on the controller to show the direction the rider has selected. When the lever is moved the controller is further operable to switch on a corresponding left or right LED lamp within the helmet at the same time which flashes to indicate the intended left or right turn of the rider.

The vehicle mounted controller unit has an incorporated accelerometer, which is operable to sense movement and the rider's position, including when the rider is slowing, coming to a stop and/or stopped. Signals from the accelerometer are processed and transmitted to control the illumination of the brake light within the helmet. Within the vehicle mounted controller unit and the helmet USB ports are provided to facilitate the charging of both units.

The vehicle mounted controller unit is operable to synchronise with the helmet mounted controller unit to enable wireless control of the different lighting devices of the helmet.

The invention will be more clearly understood from the following description of some embodiments thereof, given by way of example only, with reference to the accompanying drawings, in which:

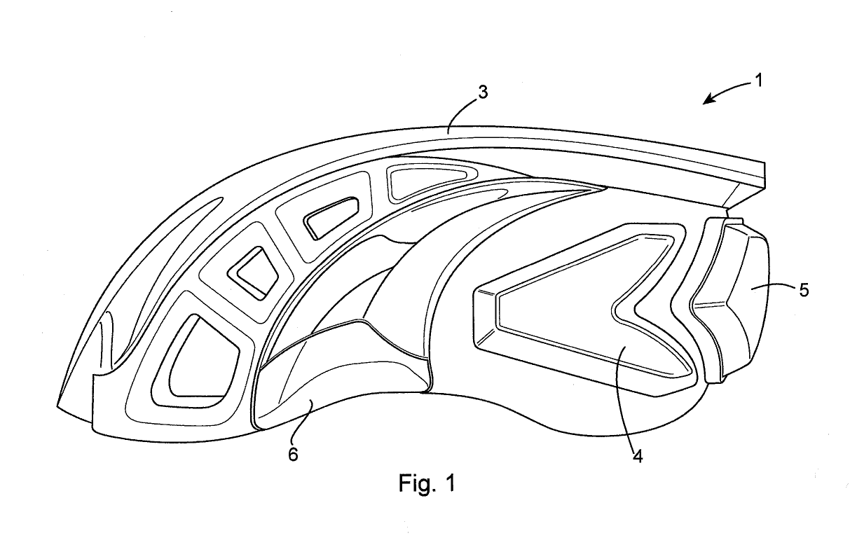

FIG. 1 is a perspective view of a helmet according to the present invention;

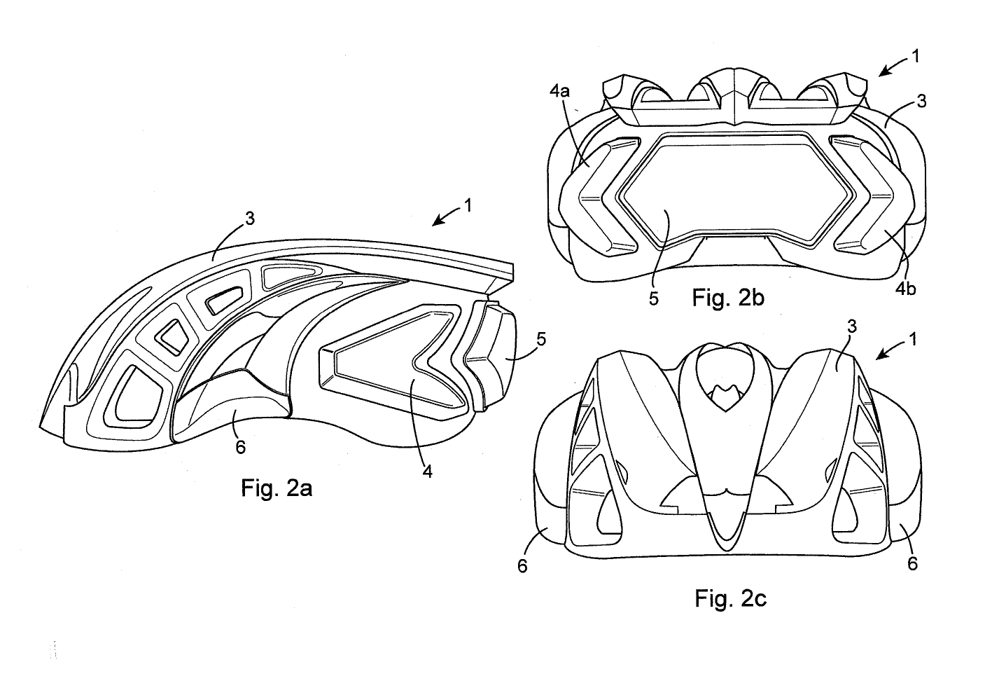

FIGS. 2a, 2b and 2c are side, back and front views of the helmet shown in FIG. 1;

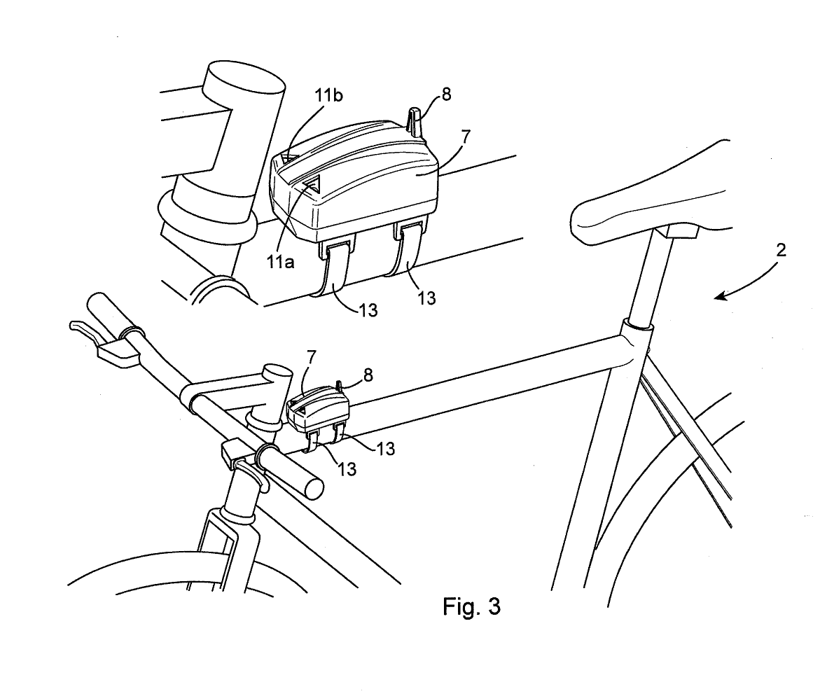

FIG. 3 is a perspective view of a vehicle mounted controller unit of a lighting system for a helmet mounted to a vehicle according to the invention;

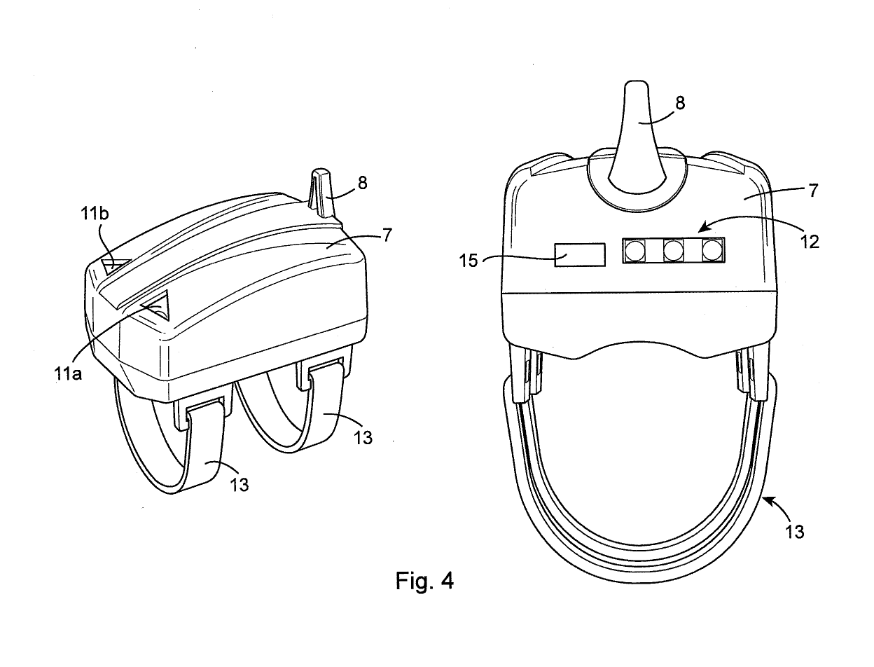

FIG. 4 are top and side perspective views of the vehicle mounted controller unit shown in FIG. 3;

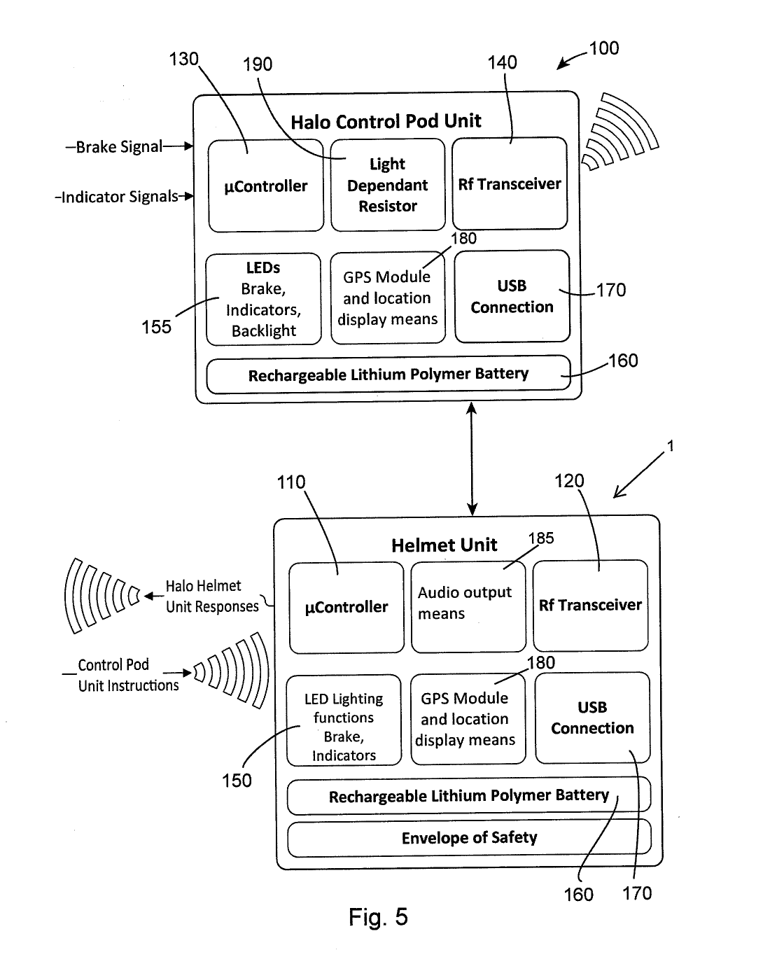

FIG. 5 is a block diagram of the lighting system according to the present invention

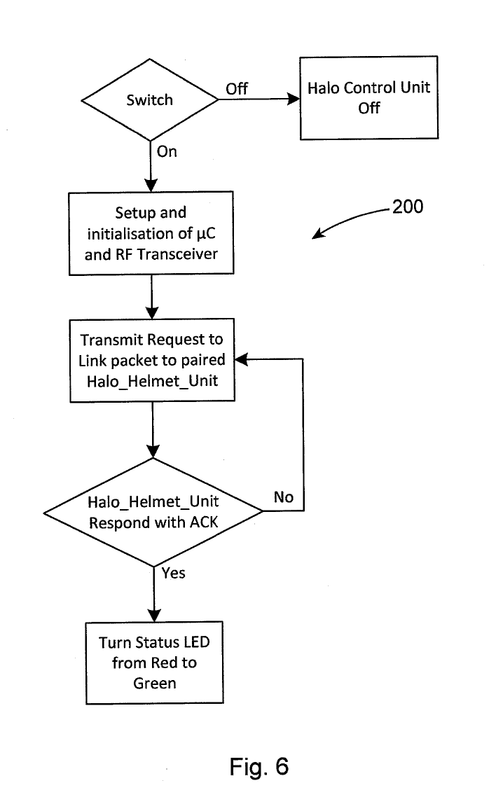

FIG. 6 is a flow diagram showing the processing steps performed during an initialisation process of the vehicle mounted controller unit with the helmet according to the invention;

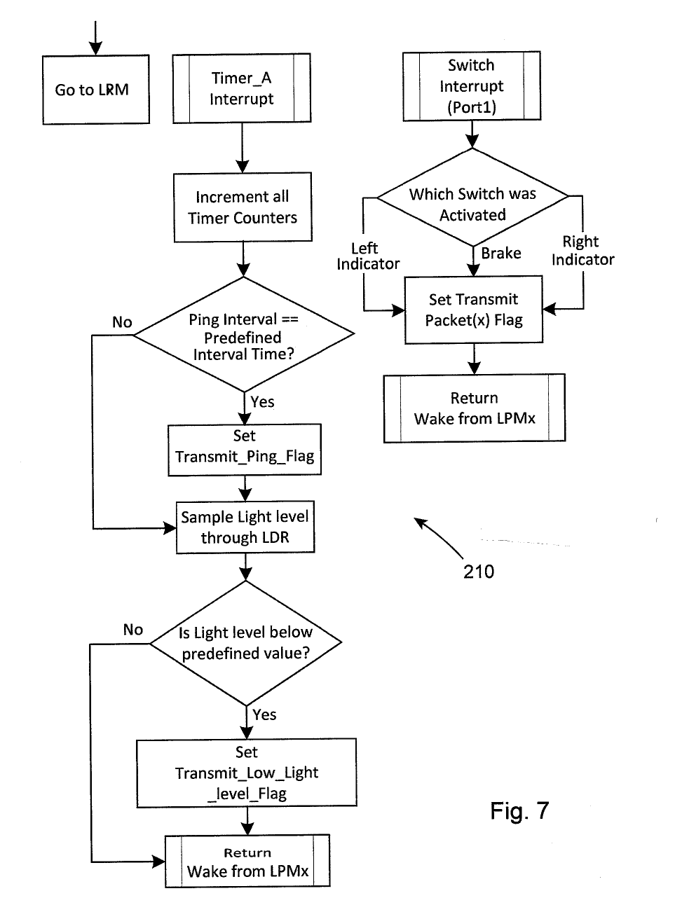

FIG. 7 is a flow diagram showing the processing steps performed during monitoring by the vehicle mounted controller unit according to the invention;

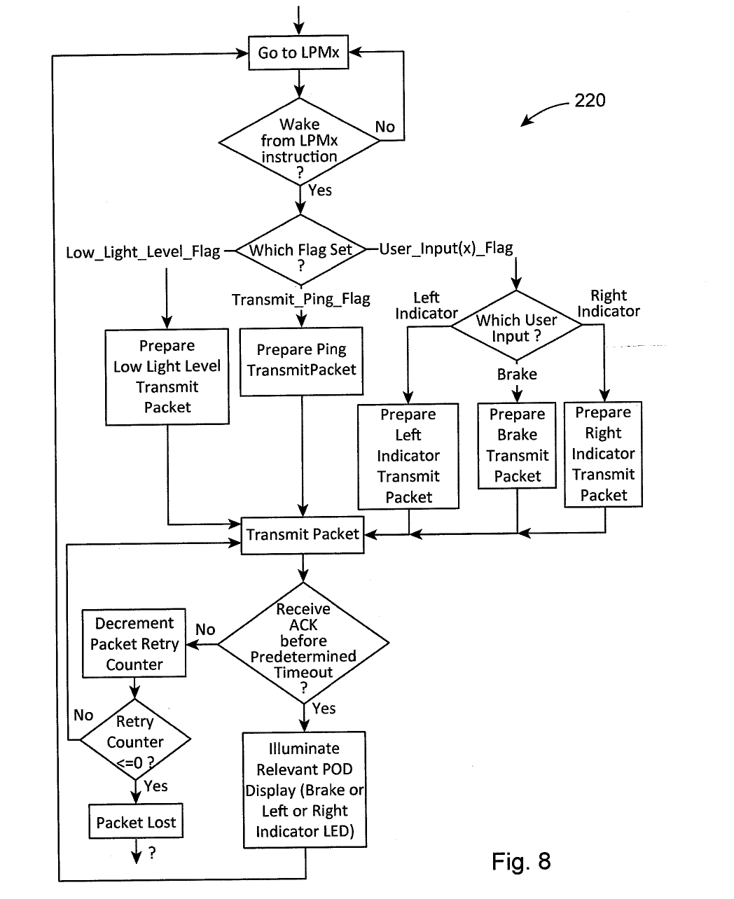

FIG. 8 is a flow diagram showing the processing steps performed during data transfer and alert processes by the vehicle mounted controller unit according to the invention;

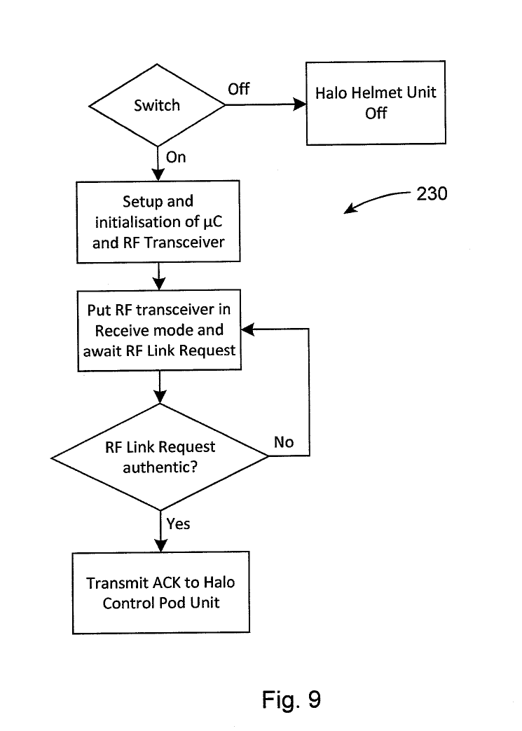

FIG. 9 is a flow diagram showing the processing steps performed during initialisation and monitoring processes of the helmet mounted controller unit according to the invention;

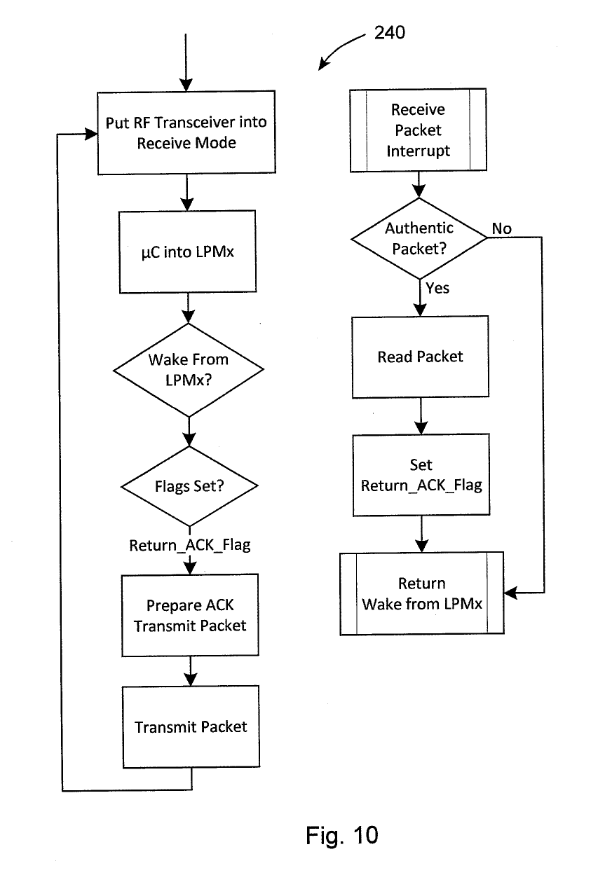

FIG. 10 is a flow diagram showing the processing steps performed during data transfer processes by the helmet mounted controller unit according to the invention;

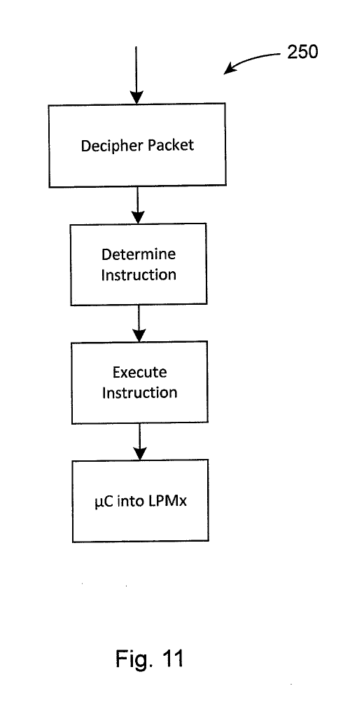

FIG. 11 is a flow diagram showing the processing steps performed during data handling processes by the helmet mounted controller unit according to the invention,

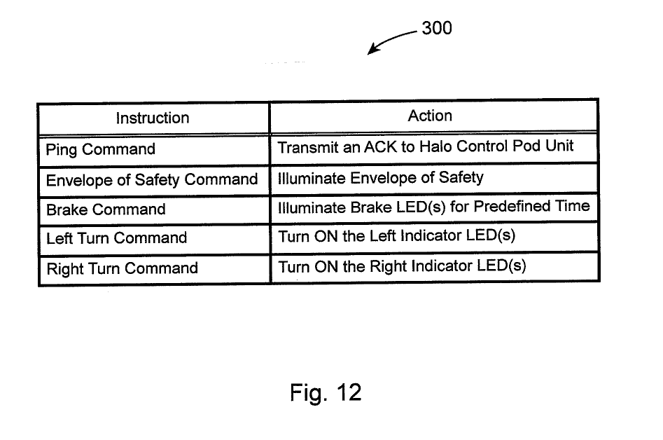

FIG. 12 is a table of instructions and relevant actions performed by the lighting system of the present invention,

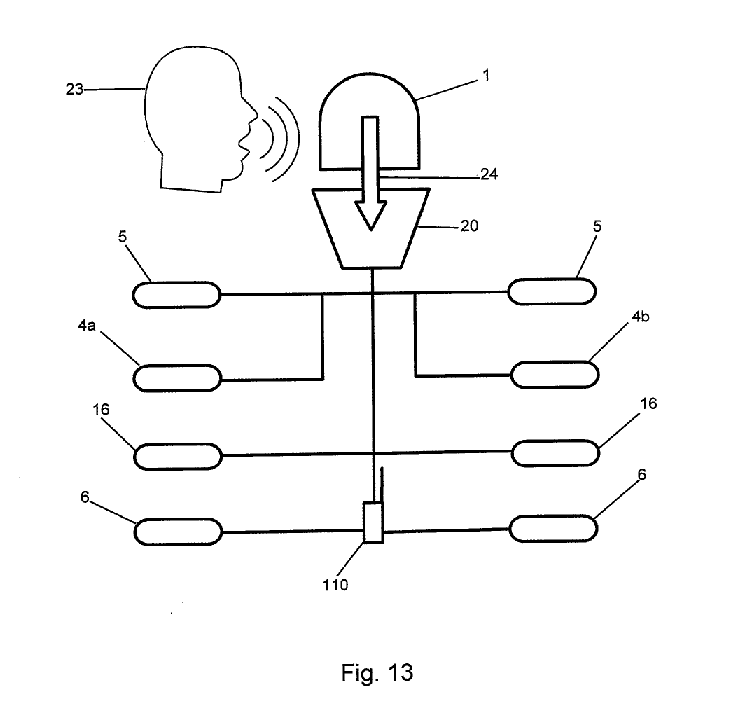

FIG. 13 is a stylised schematic of helmet comprising voice activation means according to the present invention, and

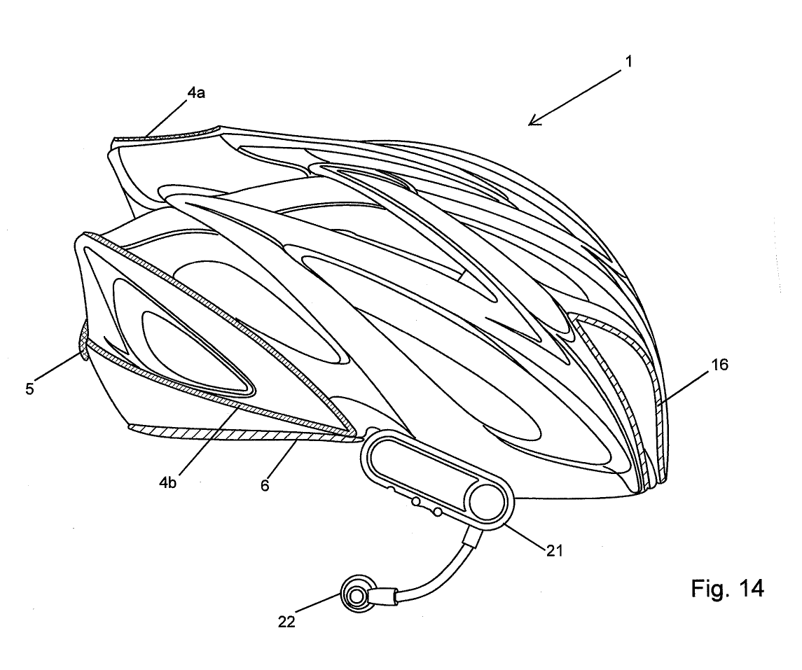

FIG. 14 is a perspective view of the helmet of FIG. 1 incorporating voice activation means according to the present invention.

Referring to the drawings, and initially to FIG. 5, there is shown a lighting system 100 for a helmet of the type worn by a user of a vehicle, such as a motorbike, bicycle, moped or scooter. The system 100 comprises a helmet mounted controller unit 110, a helmet mounted transceiver means 120, a vehicle mounted controller unit 130 and a vehicle mounted transceiver means 140.

It will be understood that the helmet mounted controller unit 110 and a helmet mounted transceiver means 120 may be provided as a computer processor means with integrated wireless data transmission means, and that the vehicle mounted controller unit 130 and a vehicle mounted transceiver means 140 may be provided as a computer processor means with integrated wireless data transmission means.

The system 100 also comprises lighting means 150 mounted to the helmet, such lighting means including left and right turning indicator lights, a brake light, and down light means operable to illuminate a region below the helmet. The lighting means 150 is operable in response to light function triggering signal 155 transmitted from the vehicle mounted controller 130 via the vehicle mounted transceiver 140.

The helmet mounted transceiver means 120 is operable for communicating with the transceiver means 140 mounted to the vehicle such that the helmet mounted controller unit 110 is operable to wirelessly activate the lighting functions 150 of the helmet in response to triggering signals 155 received from the vehicle mounted controller unit 130. Signals transmitted between helmet mounted transceiver means 120 and the vehicle mounted transceiver means 140 are one or more of GPRS signals, RF signals; digital wireless signals and/or Bluetooth signals.

The helmet mounted controller unit 110 and the vehicle mounted controller unit 130 also each comprise an integrated, optionally rechargeable, battery 160 and a USB port 170. The helmet mounted controller unit 110 and/or the vehicle mounted controller unit 130 further comprise GPS location tracking means 180 operable to enable a location of the respective controller unit 110, 130, and therefore helmet or the vehicle, to be determined. The GPS location determined is displayed on a map display means mountable to the vehicle that is in communication with the controller unit 110, 130 and/or output as an audible signal via audio output means 185 of the respective controller unit or helmet. It will be understood that the GPS location tracking means 180 enables a user to input a desired destination, and whereby directions to the destination are provided via map display means and/or audible signals via audio means 185 of the controller unit 110 or helmet 1.

FIGS. 1 to 4 show a helmet 1 according to the invention, which is of the type worn by a user of a vehicle, such as, but not limited to, a motorbike, bicycle, moped or scooter, indicated generally by the reference numeral 2. The helmet 1 comprises a main body 3 mounting one or more of: left and right turning indicator lights 4, a brake light 5, and down light means 6 operable to illuminate a region below the main body 3. The brake light 5, left and right turning indicator lights 4 and the down light means 6 each comprise LEDs operable to be switched on and off to provide a desired illumination. As shown, the left and right turning indicator lights 4 are integrally formed on the main body 3 of the helmet 1, as are the down light means 6 and the brake light 5.

The helmet 1 comprises a helmet mounted controller unit for activation of functions of the helmet 1 in response to signals received via a helmet mounted transceiver means for communicating with a transceiver means mounted to the vehicle 2. Also provided is a vehicle mounted controller unit having transceiver means enclosed within a housing 7 and being operable for wireless transmission of signals to the helmet mounted controller unit.

The turning indicator lights 4 are activated by actuator means 8 mounted to the vehicle 2 via a housing 7. As shown, the actuator means is provided as a lever 8 operable to be moved left and right, whereby movement of the lever 8 to the left activates the left turning indicator light 4a and movement of the lever 8 to the right activates the right turning indicator light 4b. The lever 8 is centrally biased.

The housing unit 7 further comprises status indicators including left indicator light 11a and right indicator light 11b operable to illuminate when the respective left indicator 4a or right indicator 4b is activated by the lever 8. Also shown are brake light, down light means and battery power status LED's 12.

The helmet 1 further comprises audio output means 185 operable to output an audio signal when the left or the right turning indictor light 4 is activated.

The brake light or brake lights 5 are integrally formed at the rear of the main body 3 of the helmet and has two modes of operation, in which in the first mode the brake light 5 is activated such that it is continuously on when the vehicle 2 is decelerating, slowing and/or is stopped, and in the second mode the brake light 5 is activated such that it flashes on and off intermittently at timed intervals when the vehicle 2 is accelerating and/or moving at a constant speed. The brake light 5 is operable in response to signals received via an accelerometer means adapted to sense the motion of the vehicle 2 and transmit signals to a vehicle mounted controller unit within the housing 7.

The down light means 6 is activated when the ambient light drops below a threshold level, such as 1000 lux; 800 lux; 600 lux; 400 lux; 200 lux or 100 lux and is operable to illuminate a region in a downward direction from the head of the wearer of the helmet 1, optionally to the ground. As shown, down light means 6 are provided at sides of the main body of the helmet. The helmet 1 also comprises an integrated, optionally rechargeable, battery and a USB port.

The housing unit 7 is releasably connectable to the vehicle, such as with straps or other connection means 13 and also comprises an integrated, optionally rechargeable, battery and a USB port 15.

The present invention thus provides a helmet having integrated electronics which communicate via a transceiver with a vehicle mounted controller unit. The invention includes integrated electronics to enable control of helmet lighting functions and communications with a vehicle mounted controller unit attached to a vehicle. The vehicle mounted controller unit communicates with the helmet mounted controller unit when an indicator is selected or braking is detected. A left and right indicator selector switch or lever is conveniently located within easy reach of a rider of the vehicle. A housing of the vehicle mounted controller unit includes status lights which are activated when the indicator lights are on. When the vehicle brakes, or should the vehicle be slowing, this is automatically detected by the vehicle mounted controller unit.

The helmet and the vehicle mounted controller unit utilise high intensity LED lights. The helmet mounted controller unit and lighting means of the helmet and the vehicle mounted controller unit each have status lights which indicate the status of the wireless link and the battery condition, which is rechargeable via the USB connection provided in both the helmet and the vehicle mounted controller unit.

An accelerometer, located inside the vehicle mounted controller unit, is operable to detect a brake condition and this triggers the sending of a wireless signal to the helmet mounted controller unit and the brake light is illuminated while a brake condition exists. To indicate an intention to turn left or right, a user selects left or right indicator by interacting with the lever located on the housing of the vehicle mounted controller unit, which sends a wireless signal to the helmet and activates the respective left or right indicator light which is illuminated for a pre-defined time or until the appropriate left or right indicator is selected again to cancel. The brake light of the helmet may be provided as a red LED integrated into the brake light unit at the rear of the helmet, and the down light means may be provided as white LED's integrated at sides of the helmet which when illuminate the cyclist's upper torso, thus increasing the cyclist's visibility to other road users. This enhanced illumination is referred to as ‘the envelope of safety’. The running light and down light means operate automatically when the system is switched on.

The use of sensing means integrated into the vehicle mounted controller unit is operable to determine if the ambient light level is low enough to activate the running light, formed as the brake light flashing at pre-defined intervals, and down light means, which activation is enabled by the vehicle mounted controller unit sending an appropriate wireless signal to the helmet mounted controller unit to enable these functions of the helmet.

The present invention is thus divided into two units, the vehicle mounted controller unit 130 and the helmet unit, comprising the helmet 1, and the helmet mounted controller unit 110. The vehicle mounted controller unit 130 will be mounted via a housing unit 7 to the vehicle 2, such as to handle bar/cross bar of a bicycle, near the centre to provide the best visibility to the cyclist.

The vehicle mounted controller unit 130 will receive signals from buttons at the brakes and/or the indicator lever, switches and/or the accelerometer and wirelessly transmits the signals to the helmet mounted controller unit 110, which may be retro fitted to the helmet 1 and visually displays via an arrangement of lighting devices, such as LEDs or other light emitting devices, a cyclist's intentions and/or actions to other road users, such as during braking or indicating an intention to turn left or right.

The vehicle mounted controller unit 130 will interpret the signals coming from brake and indicator switches and transmit the signals wirelessly to the helmet mounted controller unit 110.

The vehicle mounted controller unit 130 comprises a micro-controller having the necesary logic control electronics to generate and transmit signals to activate and control functions of the helmet 1. The vehicle mounted controller unit 130 also comprises a transceiver 140 which will enable wireless communication between the vehicle mounted controller unit 130 and the helmet mounted controller unit 110, which also comprises a transceiver 120. The transceivers 120, 140 will be used for the wireless transfer of instructions from the vehicle mounted controller unit 130 to the helmet mounted controller unit 110. Important selection factors when choosing a transceiver include the maximium range of operation and power consumption.

The housing unit 7 for the vehicle mounted controller unit 130 will also include a USB connector 170 which will allow the recharging of a battery 160, such as a Lithium Polymer Battery. The housing unit 7 will have a power and an RF link status display 12, which will display power levels and the status of the RF link to the helmet 1 and a “link lost” warning indicator. The status display will comprise of dual coloured LEDs operable to display colours, such as either red or green, to indicate alternate status as required. For example, system on status will be indicated by the red colour, while RF status OK will be indicated by the green colour. The off status will be indicated when the LED is completely off. No RF link present will be indicated with the red LED illuminated.

The vehicle mounted controller unit 130 will have a charge status display which will display charge status for battery charging and battery not charging. The vehicle mounted controller unit 130 will have a battery low indicator operable to display a battery low condition on the housing 7. The vehicle mounted controller unit 130 will further comprise a switch, which will be used to switch the vehicle mounted controller unit 130 on and off.

The vehicle mounted controller unit 130 will be powered by a battery. This battery may be charged via a micro USB connector. For optimal use of the battery, a battery gauge is operable to determine when the battery is getting low. Also provided are battery fuel gauging means, battery low interrupt warning means, and battery insertion indicator means.

The housing 7 will contain the vehicle mounted controller unit 130, the transceiver 140 and other components, which will be powered by a battery. To ensure correct operation of all components, power regulation circuitry which will be used to regulate/boost the voltage to pre-defined maximum, such as 3.3V DC. A regulator will also ensure all energy is extracted from the batteries, even when the battery voltage drops below the useable range of the components. The power regulation will be performed using a boost DC-DC convertor, this small IC based component will regulate and if necessary boost the input voltage to a fixed 3.3V. Also provided is a light dependant resistor 190 equipped and connected to the vehicle mounted controller unit 130 which will determine whether the down light means 6 of the helmet 1 should be turned on.

The vehicle mounted controller unit 130 will be coupled to an accelerometer which will attempt to determine whether the cyclist is braking in order to activate the brake light 5 on the helmet 1. Alternatively, the method by which braking is detected may comprise a switch or sensing mechanism associated with the brakes.

The helmet mounted micro-controller unit 110 will interpret the signals coming from vehicle mounted controller unit 130 and execute the relative commands and wirelessly respond with appropriate messages.

The transceiver 120 of the helmet mounted controller unit 110 is operable for two-way transmission of wireless communication signals with and between the vehicle mounted controller unit 130 in which the transceiver 120 transmits instructions from the vehicle mounted controller unit 130 to the helmet mounted controller unit 110.

Coupled to the helmet mounted controller unit 110 is a USB connector operable for recharging the battery of the helmet 1. The helmet 1 will have a charge status display which will display charge status for battery charging and battery not charging. The charge on status will be indicated by illuminating the LED while the not charging status will be indicated by the LED being off. The helmet 1 will have a battery charge indicator which will display an intermitent battery low condition on helmet 1. The helmet 1 also comprises an ON and OFF switch and a battery, such as a rechargable lithium polymer battery, chargeable via the micro USB connector. To ensure correct operation of all components of the helmet 1, power regulation circuitry is provided to regulate/boost the voltage to a fixed voltage. This regulator will also ensure all energy is extracted from the batteries, even when the battery voltage drops below the useable range of the components. The power regulation for the helmet 1 will be performed using a boost DC-DC convertor.

The down light means 6 of the helmet will contain an ‘envelope of safety’ light or arrangment of lights provided as a series of LEDs illuminating downwards towards the cyclist to aid in illuminating the cyclist when the ambient light level falls below a predefined level, as determined by sensing means 190 of the vehicle mounted controller unit 130.

The vehicle mounted controller unit 130 has means for monitoring the status of the RF link between the helmet mounted transceiver 120 and the vehicle mounted transceiver 140 of the by sending intermittent ping packets. The vehicle mounted controller unit 130 monitors the user interfacing controls i.e. braking and/or indicating, and transmits these signals via the helmet mounted transceiver 120 to the helmet mounted controller unit 110 including any braking triggers detected by the accelerometer.

FIGS. 13 and 14 show views of the helmet comprising voice activation means according to the present invention. The helmet 1 has a main body 3 and lighting functions as shown in the helmet of FIG. 1, including left and right turning indicator lights 4a, 4b, brake light 5, and down light means 6 operable to illuminate a region below the main body. Also shown are front lights 16. Voice activation means 20, in the form of a processor executed voice recognition software is mounted to the main body 3 of the helmet. It will be understood that the voice activation means 20 may be incorporated into or provided by the controller unit of the present invention, which may be provided by a mobile telephone or other processor with communication means. Coupled to the voice activation means 20 is audio input means 21 comprising a microphone 22 connected to the helmet or the helmet straps for receiving voice commands from the user 23. The voice commands 24 are transmitted to the voice activation means 20 via transmission means, such as radio frequency (RF); digital wireless, GPRS and/or Bluetooth transmission means incorporated with the audio input means 21, and the controller unit 110 is operable to receive and convert the voice commands into lighting function triggering signals for activating lighting functions of the helmet.

As in the embodiment described with respect to FIG. 1, the brake light 5 is further operable in response to lighting function triggering signals received from an accelerometer means of the controller unit 110 operable to sense the motion of the vehicle, and the down light means 6 is operable to illuminate a region between the helmet and the ground and is activated when ambient light drops below a threshold level, such a threshold level is one of: 1000 lux; 800 lux; 600 lux; 400 lux; 200 lux and 100 lux.

In the embodiment shown, once the helmet 1 has been placed on the user's head, and the ON switch has been activated to the start position, a connection for voice commands between the voice command activation means 20 within the helmet housing and the voice audio input means 21 is provided. The visual evidence of this initial connection is provided by illumination of the front lights 16 and rear running lights 5. Once the user 23 commences the journey, the voice activation software is active and ready to receive voice commands as directed from the rider via the audio input means 21.

Such voice commands are audibly spoken into the audio input means that may also be referred to as microphone headset 21 by a rider. Such commands include “Turn Right”, which will generate a signal and be transmitted to voice activation means 20 which will enable the controller unit 110 to activate the right direction indicator 4a on the helmet, which will illuminate. A small single LED will also illuminate on the helmet 1 securing strap within eye sight of the rider to alert the rider that the right indicator is illuminated. Similarly, a “Turn Left” voice command will activate the left indicator light 4b.

Once the action of turning right or left by the rider has been completed, the rider may provide a further voice command “Right Off” or “Left Off” into the microphone 21, and the respective right or left direction indicator 4a, 4b and the strap awareness LED will switch off.

The stop or brake light 5 is activated by way of an accelerometer which is housed within the helmet 1, the accelerometer will illuminate each and every time the cycle slows down or comes to a complete stop. The stop light 5 will remain on at all times the rider is in a stationary position. In a further embodiment, in addition to the accelerometer, a voice command “Stop” may also activate the stop light 5. The down light means 6 is operable when ambient light drops below a threshold level, such a threshold level is one of: 1000 lux; 800 lux; 600 lux; 400 lux; 200 lux and 100 lux. Once light/darkness is sensed, the down light means 6 will illuminate or turn off given the environment. All of the actions are controlled via pre-programmed software and a battery plus on/off switch housed within the cycle helmet.

The vehicle mounted controller unit 130 firmware may be divided into three sections, including an initialisation/setup routine, a monitoring routine, and data transfer and alerts routines.

FIG. 6 is a flow diagram showing the processing steps 200 performed during an initialisation process of the vehicle mounted controller unit with the helmet according to the invention. Initially, the vehicle mounted controller unit will remain turned off until the switch is moved to the on position. Once placed in the on position, the vehicle mounted controller unit will start up and initialise all the internal firmware parameters (such as clock speed SPI peripherals, RF link) and the transceiver will send a connection request to the helmet mounted transceiver. When the link has been established, the status LED will turn green from red to indicate an established RF link.

FIG. 7 is a flow diagram showing the processing steps 210 performed during monitoring by the vehicle mounted controller unit according to the invention. Once the RF link has been approved and established, the vehicle mounted controller unit monitors the various inputs to the vehicle mounted controller unit, such as the brake, indicators, light depdendent resistor/light sensing means, and accelerometer. Upon a user input being activated, the vehicle mounted controller unit will transmit an appropriate packet wirelessly to the helmet mounted controller unit and wait for an ACK packet to be returned. This indicates that the packet was received correctly and carried out the relevant instruction, such as brake switch activated, would transmit the packet to the helmet controller to turn on the brake lights on the helmet. Upon receiving an instruction acknowlegement, the vehicle mounted controller unit will illuminate the brake/indicator LED on the housing to indicate to the user that the instructions were executed correctly.

The ambient light levels are also monitored through the light dependent resistor on the vehicle mounted controller unit such that when the ambient light level fall below a predefined level, the vehicle mounted controller unit will transmit an instruction to the helmet mounted controller unit to turn on the down light means to activate the ‘envelope of safety’ of the helmet.

The output of the accelerometer will be continuously monitored by the vehicle mounted controller unit to attempt to determine if a braking or slowing motion is detected. Upon this detection the vehicle mounted controller unit will transmit a command to the helmet mounted controller unit to turn on the helmet brake light for a predetermined duration of time. Other methods for detecting a braking condition will be via switches/buttons at the brake levers of the vehicle. A battery gas gauge integrated circuit is also fitted to the circuit and will illuminate a red LED to indicate to the user when the battery is running low.

The firmware will also monitor the RF link between the helmet mounted transceiver and the vehicle mounted transceiver by transmitting a continual ping packet at predefined intervals to ensure the RF link is established and operational between them at all times.

FIG. 8 is a flow diagram showing the processing steps 220 performed during data transfer and alert processes by the vehicle mounted controller unit according to the invention. The vehicle mounted controller unit upon successful interrupt from user inputs or timer interrupts will display visual alerts on LEDS of the vehicle mounted controller unit and transmit appropriate packets wirelessly to the helmet mounted controller unit to execute the relevant command and then wait for an acknowlegment back from the helmet mounted controller unit.

User input alerts include brake indication, left turn indication and right turn indication and timer alerts will consist of low light level interrupts to activate the down light means of the helmet and ping interval alerts to transmit ping packets to ensure the communications link between the transceivers of the vehicle mounted controller unit and helmet mounted controller unit is still established and operational and displaying the relevant RF status through the status LEDs on the housing of the vehicle mounted controller unit.

FIG. 9 is a flow diagram showing the processing steps 230 performed during initialisation and monitoring processes of the helmet mounted controller unit according to the invention. As shown, the helmet mounted controller unit will receive wireless instructions via the helmet transceiver from the vehicle mounted controller unit. The helmet mounted controller unit will execute the instructions received from vehicle mounted controller unit such as illuminating the down light means, the brake lights and left and right indicators. The helmet mounted controller unit is also responsible for responding wirelessly with appropriate packets (packet acknowledgements) when an authentic instruction is received from vehicle mounted controller unit.

The helmet mounted controller unit will remain turned off until a switch is moved to the ON position. Once placed in the ON position, the helmet mounted controller unit will start up and initialise all the internal firmware parameters (Clock speed SPI peripherals, RF) and the transceiver will go into a receive mode and await a connection request from the vehicle mounted controller unit. When the helmet mounted controller unit receives an authentication request it responds to the helmet mounted controller unit with an acknowledgement (ACK) thus establishing the communications link. The helmet mounted controller unit is then set in receive mode to await communication and instructions from the vehicle mounted controller unit.

FIG. 10 is a flow diagram showing the processing steps 240 performed during data transfer processes by the helmet mounted controller unit according to the invention. When a packet is received correctly the helmet mounted controller unit must first transmit an ACK packet to the vehicle mounted controller unit to confirm that the helmet mounted controller unit successfully received the transmitted packet.

FIG. 11 is a flow diagram showing the processing steps 250 performed during data handling processes by the helmet mounted controller unit according to the invention. After successful reception and acknowledgment of a packet from the vehicle mounted controller unit the helmet mounted controller unit must decipher the packet, and in particular, what is being instructed by the vehicle mounted controller unit. FIG. 12 shows a table 300 of system instructions and relevant action performed.

Aspects of the present invention have been described by way of example only and it should be appreciate that additions and/or modifications may be made thereto without departing from the scope thereof as defined in the appended claims.

1. A lighting system for a helmet of the type worn by a user of a vehicle, such as a motorbike, bicycle, moped or scooter, the system comprising an arrangement of a helmet and a vehicle mounted controller unit and transceiver means, the helmet comprising:
a main body mounting lighting functions comprising one or more of: left and right turning indicator lights, a brake light, and down light means operable to illuminate a region below the main body;
a helmet mounted controller unit in communication with the lighting functions, and
a helmet mounted transceiver means,
whereby, the vehicle mounted controller unit is operable to generate triggering signals for the lighting functions, and the transceiver means mounted to the vehicle is provided for transmission of the lighting function triggering signals to the helmet mounted transceiver means, and in which the helmet mounted controller unit is operable to activate lighting functions of the helmet in response to the lighting function triggering signals received by the helmet mounted transceiver means.

2. The lighting system for a helmet as claimed in claim 1, in which the vehicle mounted controller unit and vehicle mounted transceiver means are enclosed in a housing unit.

3. The lighting system for a helmet as claimed in claim 2, in which the housing unit comprises status indicators for indicating a status of the left and the right turning indicator lights, the brake light and/or the down light means.

4. The lighting system for a helmet as claimed in claim 2, in which the housing unit comprises releasable connection means, such as straps or other connection means, for connection to the vehicle.

5. The lighting system for a helmet as claimed in claim 2, in which the housing unit is mounted at a position on a cross-bar or a handle bar of the vehicle.

6. The lighting system for a helmet as claimed claim 1, in which actuator means of the vehicle mounted controller unit is provided to generate lighting function triggering signals to activate the left and right turning indicator lights.

7. The lighting system for a helmet as claimed in claim 6, in which the actuator means is provided as a lever of the housing unit operable to be moved left and right, whereby movement of the lever generates lighting function triggering signals such that movement of the lever to the left activates the left turning indicator light and movement of the lever to the right activates the right turning indicator light.

8. The lighting system for a helmet as claimed in claim 6, in which the lever is centrally biased.

9. The lighting system for a helmet as claimed in claim 6, in which the actuator means is provided as a button or a lever mountable to a left side handle bar of the vehicle, and the actuator means for activating the right turning indicator light is provided as a lever or button mountable to a right side handle bar of the vehicle, whereby movement of a lever or activation of a button generates lighting function triggering signals to activate the left turning indicator light and the right turning indicator light.

10. The lighting system for a helmet as claimed in claim 1, in which the lighting function triggering signals are transmitted between the helmet mounted transceiver means and the vehicle mounted transceiver means as one or more of radio frequency (RF) signals; digital wireless signals, GPRS signals and/or Bluetooth signals.

11. The lighting system for a helmet as claimed in claim 1, in which the helmet further comprises audio output means operable to output an audio signal when the left or the right turning indicator light is activated.

12. The lighting system for a helmet as claimed in claim 1, in which the brake light has two modes of operation, whereby in the first mode the brake light is activated such that it is continuously on when the vehicle is decelerating, slowing and/or is stopped, and in the second mode the brake light is activated such that the brake light flashes on and off intermittently at timed intervals when the vehicle is accelerating and/or moving at a constant speed.

13. The lighting system for a helmet as claimed in claim 12, in which the brake light is operable in response to lighting function triggering signals received from an accelerometer means adapted to sense the motion of the vehicle.

14. The lighting system for a helmet as claimed in claim 1, in which the down light means is provided at left and right sides of the main body of the helmet and is activated when ambient light drops below a threshold level and operable to illuminate a region between the helmet and the ground when worn on the head of a user in normal usage.

15. The lighting system for a helmet as claimed in claim 1, in which the helmet and/or the vehicle mounted controller unit comprises a USB port and/or a rechargeable battery.

16. The lighting system for a helmet as claimed in claim 1 any one of the preceding claims, in which, one of the: helmet mounted controller unit and the vehicle mounted controller unit further comprises GPS location tracking means operable to enable a location of the respective controller unit to be determined, and the GPS location determined is displayed on a map display means mountable to the vehicle in communication with the controller unit and/or output as an audible signal via audio output means of the respective controller unit or helmet.

17. The lighting system for a helmet as claimed in claim 16, in which the GPS location tracking means enables a user to input a desired destination, and whereby directions to the destination are provided via map display means and/or audible signals via audio means of the controller unit or helmet.

18. A helmet of the type worn by a user of a vehicle, such as a motorbike, bicycle, moped or scooter, the helmet comprising:
a main body mounting voice activated lighting functions comprising one or more of: left and right turning indicator lights, a brake light, and down light means operable to illuminate a region below the main body;
voice activation means comprising audio input means for receiving voice commands from the user,
a controller unit in communication with the voice activation means and lighting functions of the helmet,
whereby, the controller unit is operable to receive and convert the voice commands into lighting function triggering signals for activating lighting functions of the helmet.

19. The helmet as claimed in claim 18, in which the controller unit is mounted to the main body of the helmet.

20. The helmet as claimed in claim 18, in which the main body comprises a housing for the controller unit, and the housing unit comprises releasable connection means, such as straps or other connection means, for connection of the controller unit to the helmet.

21. The helmet as claimed in claim 18, in which the controller unit is integrated as a computer processor means or mobile telephone with computer processor within the helmet.

22. The helmet as claimed in claim 18, in which the brake light is operable in response to lighting function triggering signals received from an accelerometer means of the controller unit operable to sense the motion of the vehicle.

23. The helmet as claimed in claim 18, in which the down light means is provided at left and right sides of the main body of the helmet and is operable to illuminate a region between the helmet and the ground when worn by a user and in which the down light means is activated when ambient light drops below a threshold level.

24. The helmet as claimed in claim 18, in which the controller unit further comprises GPS location tracking means operable to enable a location of the controller unit to be determined, and the GPS location determined is displayed on a map display means mountable to the vehicle in communication with the controller unit and/or output as an audible signal via audio output means of the controller unit or helmet.

25. The helmet as claimed in claim 24, in which the GPS location tracking means enables a user to input a desired destination and whereby directions to the destination are provided via map display means and/or audible signals via audio means of the controller unit or helmet.
